(19) United States
(12) Patent Application Publication
(10) Pub. No.: US 2026/0204486 A1
(43) Pub. Date: Jul. 16, 2026

(54) MULTILAYER CERAMIC CAPACITOR

(71) Applicant: Murata Manufacturing Co., Ltd., Nagaokakyo-shi (JP)

(72) Inventors: Akira ISHIZUKA, Nagaokakyo-shi (JP); Shinya ISOTA, Nagaokakyo-shi (JP)

(21) Appl. No.: 19/566,113

(22) Filed: Mar. 13, 2026

Related U.S. Application Data
(63) Continuation of application No. PCT/JP2024/039380, filed on Nov. 6, 2024.

(30) Foreign Application Priority Data
Dec. 26, 2023 (JP) 2023-219585

(51) Int. Cl. H01G 4/30; H01G 4/012; H01G 4/12; H01G 4/232

(52) U.S. Cl. CPC H01G 4/30; H01G 4/012; H01G 4/1227; H01G 4/2325

(57) ABSTRACT

A multilayer ceramic capacitor includes a multilayer body, and an outer electrode. The multilayer body includes two major surfaces, two end surfaces, and two side surfaces. The outer electrode is provided on each end surface of the multilayer body. The multilayer body includes an inner layer portion, and an outer layer portion on opposite sides of the inner layer portion in a stacking direction. The inner layer portion includes an inner electrode, and an inner dielectric layer. The outer layer portion and the inner dielectric layer each include barium titanate as a major component, and Si as a minor component. A skewness of Si in the inner dielectric layer within a gap region is greater than the skewness of Si in the outer layer portion.

### CROSS REFERENCE TO RELATED APPLICATIONS

This application claims the benefit of priority to Japanese Patent Application No. 2023-219585 filed on Dec. 26, 2023 and is a Continuation Application of PCT Application No. PCT/JP 2024/039380 filed on Nov. 6, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors generally include an inner layer portion in which inner electrodes and dielectric layers are stacked alternately. An outer layer portion is disposed on opposite sides of the inner layer portion in the stacking direction. The inner layer portion includes an effective layer, which contributes to capacitance formation. A gap portion, which does not contribute to capacitance formation, is disposed at the outer periphery portion of the effective layer in a direction orthogonal to the stacking direction. Portions such as the outer layer portion and the gap portion contribute to reliability such as moisture resistance.

In recent years, multilayer ceramic capacitors are increasingly required to be smaller and thinner while also being required to provide greater capacitance. Since the inner layer portion contributes to capacitance formation, there is a limit on how much the inner layer portion can be reduced in size. Therefore, to achieve overall miniaturization and thickness reduction, portions such as the outer layer portion and the gap portion are further reduced in thickness.

Making portions such as the outer layer portion and the gap portion thinner may, however, result in reduced reliability. A related-art technique to address this issue involves providing an insulating layer so as to cover the outer side portion of the outer layer portion (see, for example, Japanese Unexamined Patent Application Publication No. 2023-113923).

However, when an insulating layer is to cover the outer side portion of the outer layer portion as in the case of the related-art technique described above, an insulating-layer providing step is additionally required. Further, the presence of such an insulating layer increases the thickness of the resulting multilayer body.

### SUMMARY OF THE INVENTION

Example embodiments of the present invention provide multilayer ceramic capacitors that each enable miniaturization and thickness reduction while improving moisture resistance.

An example embodiment of the present invention provides a multilayer ceramic capacitor including a multilayer body and an outer electrode. The multilayer body includes two major surfaces that are opposite to each other in a stacking direction, two end surfaces that are opposite to each other in a longitudinal direction intersecting the stacking direction, and two side surfaces that are opposite to each other in a transverse direction which intersects the stacking direction and the longitudinal direction. The outer electrode is provided on each of the two end surfaces of the multilayer body. The multilayer body includes an inner layer portion, and an outer layer portion on opposite sides of the inner layer portion in the stacking direction. The inner layer portion includes an inner electrode, and an inner dielectric layer. The outer layer portion and the inner dielectric layer each include barium titanate as a major component, and Si as a minor component. A gap region is located between the inner electrode and each of the two end surfaces or between the inner electrode and each of the two side surfaces. A skewness of Si in the inner dielectric layer within the gap region is greater than a skewness of Si in the outer layer portion.

The present invention provide multilayer ceramic capacitors that each enable miniaturization and thickness reduction while improving moisture resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to an example embodiment of the present invention.

FIG. 2 is a cross-sectional view taken along a line II-II in FIG. 1.

FIG. 3 is a cross-sectional view taken along a line III-III in FIG. 1.

FIGS. 4A and 4B schematically show images of Si mapped by WDX, in which FIG. 4A illustrates an outer layer portion and FIG. 4B illustrates a gap region.

FIG. 5 illustrates a formula for calculating skewness.

### DETAILED DESCRIPTION OF THE EXAMPLE EMBODIMENTS

Example embodiments of the present invention will be described in detail below with reference to the drawings.

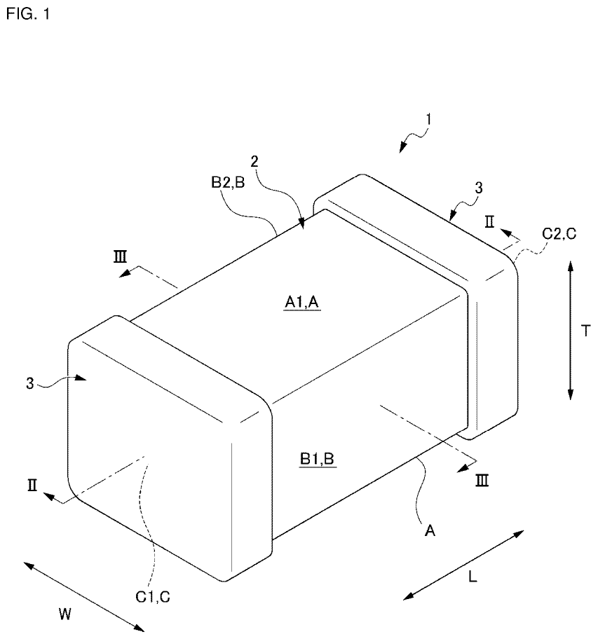

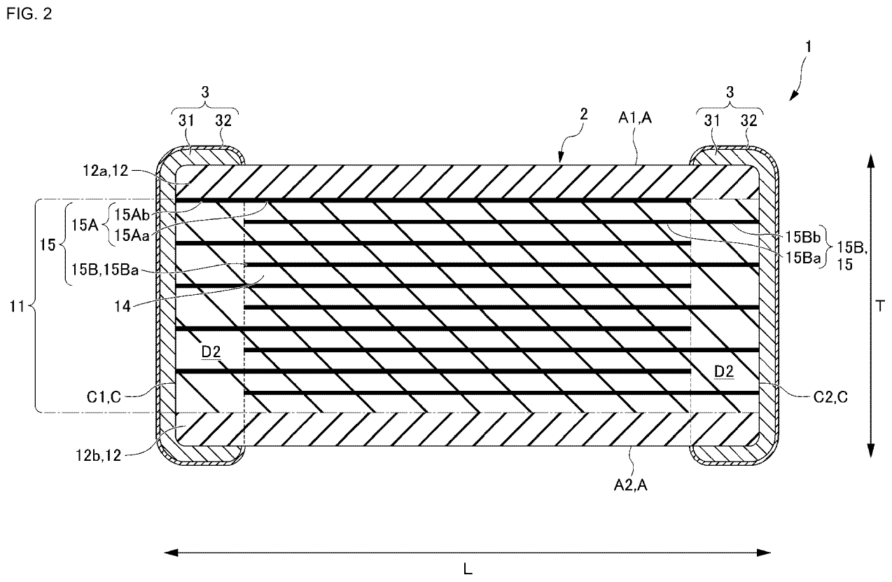

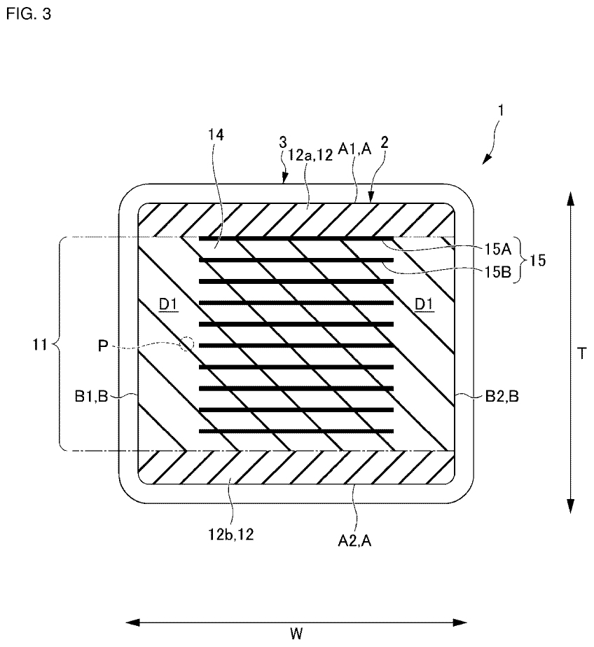

A multilayer ceramic capacitor 1 according to an example embodiment of the present invention will now be described. FIG. 1 is a schematic perspective view of the multilayer ceramic capacitor 1. FIG. 2 is a cross-sectional view taken along a line II-II in FIG. 1. FIG. 3 is a cross-sectional view taken along a line III-III in FIG. 1.

The multilayer ceramic capacitor 1 is cuboid or substantially cuboid in shape. The multilayer ceramic capacitor 1 includes a multilayer body 2, and a pair of outer electrodes 3 disposed at opposite ends of the multilayer body 2. The multilayer body 2 includes an inner layer portion 11 and at least one outer layer portion 12. In the inner layer portion 11, a plurality of inner dielectric layers 14 and a plurality of inner electrodes 15 are stacked.

In the following description, directions associated with the multilayer ceramic capacitor 1 are defined as described below. A direction in which the inner dielectric layer 14 and the inner electrode 15 are stacked is defined as a stacking direction T. A direction intersecting the stacking direction T and in which the pair of outer electrodes 3 are disposed is defined as a longitudinal direction L. A direction intersecting both the longitudinal direction L and the stacking direction T is defined as a transverse direction W. According to an example embodiment of the present invention, the transverse direction W is orthogonal or substantially orthogonal to both the longitudinal direction L and the stacking direction T.

Hereinafter, of the six outer peripheral surfaces of the multilayer body 2 illustrated in FIG. 2, the pair of outer peripheral surfaces opposite to each other in the stacking direction T will be referred to as a first major surface A1 and a second major surface A2, and the first major surface A1 and the second major surface A2 will be collectively referred to as a major surface A when there is no particular need to distinguish therebetween.

The pair of outer peripheral surfaces of the multilayer body 2 that are opposite to each other in the transverse direction W will be referred to as a first side surface B1 and a second side surface B2, and the first side surface B1 and the second side surface B2 will be collectively referred to as a side surface B when there is no particular need to distinguish therebetween. The pair of outer peripheral surfaces of the multilayer body 2 that are opposite to each other in the longitudinal direction L will be referred to as a first end surface C1 and a second end surface C2, and the first end surface C1 and the second end surface C2 will be collectively referred to as an end surface C when there is no particular need to distinguish therebetween.

Both or one of the first major surface A1 and the second major surface A2 is preferably flat. If the major surface A is flat, stress exerted by a nozzle in picking up the multilayer ceramic capacitor 1 can be distributed over the flat major surface A. This makes it possible to improve the strength of the multilayer ceramic capacitor 1 during mounting. This, however, is not intended to be limiting. Alternatively, both of the first major surface A1 and the second major surface A2 of the multilayer body 2 may be rough.

A portion where two of the first major surface A1, the second major surface A2, the first end surface C1, the second end surface C2, the first side surface B1, and the second side surface B2 meet is referred to as an edge, and a portion where three of these faces meet is referred to as a corner. Such edges and corners are preferably rounded. The rounding makes it possible to prevent chipping and cracking. When the edges and corners are rounded, the major surfaces may be flat except at the corners and edges.

The inner layer portion 11 includes the inner electrodes 15, and the inner dielectric layers 14 stacked alternately with the inner electrodes 15.

The inner electrodes 15 include a first inner electrode 15A exposed at one end on the first end surface C1, and a second inner electrode 15B exposed at one end on the second end surface C2. The first inner electrode 15A and the second inner electrode 15B are stacked alternately.

The inner electrode 15 preferably has a thickness of, for example, greater than or equal to about 0.25 μm and less than or equal to about 0.6 μm. In one non-limiting example, the inner electrode 15 may be made of any suitable conductive material, examples of which include metals such as Ni, Cu, Ag, Pd, or Au or alloys including at least one of these metals, such as an Ag—Pd alloy. When the inner electrode 15 includes Sn, this helps to reduce electric field concentration at the interface between the inner electrode 15 and the inner dielectric layer 14, and leads to improved high-temperature load reliability. In this regard, to achieve the above-described effect, it may suffice that Sn is included only in one of the first inner electrode 15A and the second inner electrode 15B.

The first inner electrode 15A includes a first opposed portion 15Aa opposed to the second inner electrode 15B, and a first extended portion 15Ab extending from the first opposed portion 15Aa onto the first end surface C1. The second inner electrode 15B includes a second opposed portion 15Ba opposed to the first inner electrode 15A, and a second extended portion 15Bb extending from the second opposed portion 15Ba onto the second end surface C2.

The first opposed portion 15Aa and the second opposed portion 15Ba are opposed to each other, and a capacitance is generated between the first opposed portion 15Aa and the second opposed portion 15Ba. This allows the multilayer ceramic capacitor 1 to provide characteristics of a capacitor.

The first opposed portion 15Aa and the second opposed portion 15Ba will be collectively referred to as an opposed portion 15a when there is no particular need to distinguish therebetween. The first extended portion 15Ab and the second extended portion 15Bb will be collectively referred to as an extended portion 15b when there is no particular need to distinguish therebetween.

Each inner dielectric layer 14 includes, for example, barium titanate as a major component, and Si as a minor component. The inner dielectric layer 14 has a thickness of, for example, less than or equal to about 0.45 μm in the stacking direction T. The inner dielectric layer 14 of the inner layer portion 11 of the multilayer ceramic capacitor 1 includes ceramic grains. The inner dielectric layer 14 preferably has a ceramic grain size D50 of, for example, less than or equal to about 0.15 μm. This makes it possible to increase the number of ceramic grains included in the inner dielectric layer 14. This in turn increases the number of interfaces between ceramic grains, leading to improved high-temperature reliability.

As illustrated in FIG. 3, in the inner layer portion 11, a region between the inner electrode 15 and the side surface B is referred to as a side-surface gap region D1. As illustrated in FIG. 2, a region between the first inner electrode 15A and the second end surface C2, and a region between the second inner electrode 15B and the first end surface C1, that is, a region of the inner layer portion 11 where the extended portion 15b exists in the stacking direction T is referred to as an extended region D2. The side-surface gap region D1 and the extended region D2 will be collectively referred to as a gap region D.

According to the present example embodiment, the content of Si in the inner dielectric layer 14 located within the side-surface gap region D1 and in a vicinity of the center in the stacking direction T is preferably, for example, greater than or equal to about 0.2 atomic percent (at %) and less than or equal to about 5.0 at %.

When the content of Si within the dielectric ceramic material in the side-surface gap region D1 is less than about 0.2 at %, it is more difficult for sintering to proceed. According to example embodiments of the present invention, however, the content of Si within the dielectric ceramic material in the side-surface gap region D1 is, for example, greater than or equal to about 0.2 at %, which makes it possible to facilitate sintering in the inner dielectric layer 14. In particular, this makes it possible to reduce the possibility of moisture entering through the first side surface B1 and the second side surface B2 that are not covered by the outer electrode 3 and reaching the inner electrode 15. Therefore, moisture resistance is improved.

When the content of Si within the dielectric ceramic material in the side-surface gap region D1 is greater than about 5.0 at %, the resulting reduction in dielectric constant leads to a pronounced decrease in capacitance. According to example embodiments of the present invention, however, the content of Si within the dielectric ceramic material in the side-surface gap region D1 is, for example, less than or equal to about 5.0 at %, and thus the problem of decreased capacitance due to a reduced dielectric constant is less likely to occur.

According to the present example embodiment, the content of Si in the inner dielectric layer 14 located in a vicinity of the center in the stacking direction T of the side-surface gap region D1 is, for example, greater than or equal to about 0.2 at % and less than or equal to about 5.0 at %. This, however, is not intended to be limiting. As long as the content of Si in the inner dielectric layer 14 located in a vicinity of the center in the stacking direction T of the side-surface gap region D1 is, for example, greater than or equal to about 0.2 at % and less than or equal to about 5.0 at %, it possible to reduce the possibility of moisture entering through the first side surface B1 and the second side surface B2 that are not covered by the outer electrode 3 and reaching the inner electrode 15.

The content of Si can be measured as described below. For example, in the case of the side-surface gap region D1, in the cross-section in FIG. 3 taken in a vicinity of the center in the longitudinal direction L, a region of φ1 μm located about 5 μm outward (toward the side surface B) in the transverse direction W from an end portion of the inner electrode 15 at substantially a ½ position in the stacking direction T is defined as a region P. The content of Si is calculated from the X-ray intensity spectrum detected within the region P by a wavelength-dispersive X-ray fluorescence spectrometer (WDX).

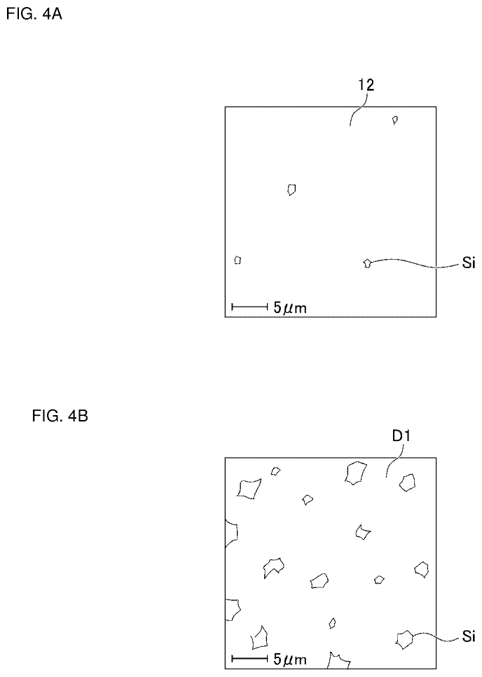

FIGS. 4A and 4B schematically show images of Si mapped by WDX, in which FIG. 4A illustrates the outer layer portion 12, and FIG. 4B illustrates the side-surface gap region D1. According to the present example embodiment, the content of Si in the outer layer portion 12 is less than the content of Si in the side-surface gap region D1.

The multilayer body 2 includes the inner layer portion 11, and two outer layer portions 12 sandwiching the inner layer portion 11 in the stacking direction T. Of the two outer layer portions 12, the outer layer portion 12 near the first major surface A1 is referred to as a first outer layer portion 12a, and the outer layer portion 12 near the second major surface A2 is referred to as a second outer layer portion 12b. The first outer layer portion 12a and the second outer layer portion 12b are each made of an insulating material.

According to the present example embodiment, the outer layer portion 12 includes, for example, barium titanate as a major component, and Si and Mn as minor components.

According to the present example embodiment, the skewness of Si included in the outer layer portion 12 and in the inner dielectric layer 14 within the side-surface gap region D1 is preferably, for example, greater than or equal to about 0 and less than or equal to about 0.5. This makes it possible to improve moisture resistance without adversely affecting high-temperature reliability. Since the above-described configuration makes it possible to reduce the possibility of moisture entering through the outer layer portion 12 and the first and second side surfaces B1 and B2 and reaching the inner electrode 15, moisture resistance improves.

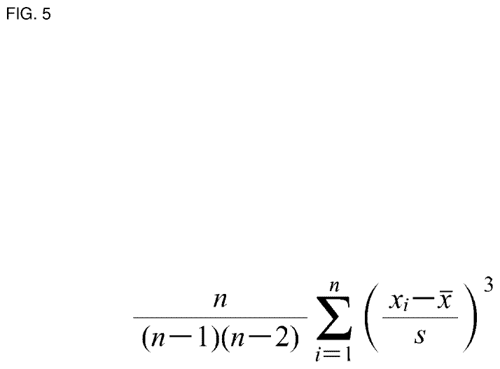

The skewness of Si is calculated by a method described below. First, the multilayer ceramic capacitor 1 is cross-sectionally polished to the position illustrated in FIG. 3, and the detected X-ray intensity of Si in each grid cell is measured by WDX. More specifically, an approximately 5-μm-square observation field of view is divided into 38×38 grid cells, and the content of Si is measured from the X-ray intensity spectrum in each grid cell. Then, the formula in FIG. 5 is used to compute the skewness of Si. The formula in FIG. 5 can also be calculated automatically. The formula in FIG. 5 indicates how much a distribution is skewed from the normal distribution, and represents a measure of the symmetry of the distribution. In the formula, n denotes sampling size, x denotes the mean of data xi (i: 1, 2, 3 . . . , n), and s denotes standard deviation.

Further, the skewness of Si included in the inner dielectric layer 14 within the side-surface gap region D1 is greater than the skewness of Si included in the outer layer portion 12. That is, the particles of Si included in the inner dielectric layer 14 within the side-surface gap region D1 have greater variations in size than the particles of Si included in the outer layer portion 12. In other words, the particles of Si included in the outer layer portion 12 are more uniform in size than the particles of Si included in the inner dielectric layer 14 within the side-surface gap region D1. In still other words, the segregation of Si included in the inner dielectric layer 14 within the side-surface gap region D1 is more pronounced than the segregation of Si included in the outer layer portion 12.

The skewness of Si included in the inner dielectric layer 14 within the side-surface gap region D1 is preferably greater by, for example, about 0.5% or more than the skewness of Si included in the outer layer portion 12.

The greater the skewness of Si, the greater the improvement in moisture resistance, and thus the greater the improvement in the moisture resistance of the inner dielectric layer 14.

As illustrated in FIG. 3, no inner electrode 15 is present in the side-surface gap region D1. Therefore, in the side-surface gap region D1, the thickness in the stacking direction T decreases by an amount corresponding to the inner electrode 15, in comparison to the central opposed region where the inner electrode 15 and the inner dielectric layer 14 are stacked alternately. This results in a step being located between the side-surface gap region D1 and the opposed region.

According to the present example embodiment, the inner dielectric layers 14 each have a thickness of, for example, less than or equal to about 0.45 μm in the stacking direction T. When each single inner dielectric layer 14 is thin as described above, the overall capacitance increases.

However, as the inner dielectric layer 14 becomes thinner relative to the inner electrode 15, the inner electrode 15 occupies a larger proportion of the overall thickness of the opposed portion in the stacking direction T. As a result, the step created depending on whether the inner electrode 15 is present has a greater effect on the overall thickness of the multilayer body 2 in the stacking direction T. This tends to result in, at the location of the step, decreased denseness in the side-surface gap region D1 when a sheet stack is subjected to pressing in the stacking direction T as will be described later.

In this regard, in the multilayer ceramic capacitor 1 according to the present example embodiment, the skewness of Si included in the inner dielectric layer 14 within the side-surface gap region D1 is greater than the skewness of Si included in the outer layer portion 12. The greater the skewness of Si, the greater the improvement in moisture resistance, and thus the greater the improvement in the moisture resistance of the inner dielectric layer 14.

Further, according to the present example embodiment, the content of Mn in the outer layer portion 12 is greater than the content of Mn in the inner dielectric layer 14 located within the side-surface gap region D1 and in a vicinity of the center in the stacking direction T. This makes it possible to further improve the high-temperature reliability of the outer layer portion 12.

Increasing the content of Mn in the outer layer portion 12 makes it possible to improve the denseness of the outer layer portion, and thus improve the reliability against moisture.

In this regard, improving the reliability against moisture only in the outer layer by using Mn as described above results in a relatively low moisture resistance in the side-surface gap region D1. To address this, in the gap region D1, the reliability against moisture is improved by the segregation of Si.

The outer electrodes 3 include a first outer electrode 3A and a second outer electrode 3B. The first outer electrode 3A is connected to the first inner electrode 15A, and disposed on the first end surface C1. The first outer electrode 3A also includes a fold-back portion extending to a portion of the major surface and to a portion of the side surface B. The second outer electrode 3B is connected to the second inner electrode 15B, and disposed on the second end surface C2. The second outer electrode 3B also includes a fold-back portion extending to a portion of the major surface and to a portion of the side surface B. Hereinafter, the first outer electrode 3A and the second outer electrode 3B will be collectively referred to as the outer electrode 3 when there is no particular need to distinguish therebetween.

The outer electrode 3 includes a base electrode layer 31, and a plating layer 32 disposed on the base electrode layer 31. The base electrode layer 31 includes, for example, a metal and a glass component. Examples of the metal include at least one of copper, nickel, silver, palladium, a silver-palladium alloy, or gold. According to the present example embodiment, the metal is gold, for example. Examples of the glass component include boron or silicon. The plating layer 32 may include, for example, a Ni (nickel) plating layer disposed on the base electrode layer 31, and a Sn (tin) plating layer disposed on the Ni plating layer.

The skewness of Si within the outer layer portion 12 and the skewness of Si within the side-surface gap region D1 can be made different from each other by the difference in the particle size of Si-containing particles to be included in the dielectric paste, for example, glass particles, between the dielectric paste used for forming the outer layer portion and the dielectric paste used for forming the inner dielectric layers.

Specifically, for example, in the dielectric paste used for the inner dielectric layer, the particle size of glass particles defining and functioning as reference glass particles is set to be greater than or equal to about 0.005 μm and less than or equal to about 0.5 μm, and glass particles with a particle size larger than that of the reference glass particles by about 1.0 μm are mixed at a content greater than or equal to about 0.01 Vol % and less than or equal to about 40 Vol % into the dielectric paste used for forming the inner dielectric layers. The particle size of glass particles to be included in the dielectric paste used for forming the outer layer portion is set to be, for example, greater than or equal to about 0.005 μm and less than or equal to about 0.5 μm.

Then, on top of dielectric sheets produced by using the dielectric paste used for forming the inner dielectric layers, a conductive paste used for forming the inner electrodes is applied in, for example, a predetermined pattern. An inner electrode pattern is thus formed on the corresponding dielectric sheet. The inner electrode pattern can be formed by a method such as screen printing or gravure printing, for example.

Subsequently, a predetermined number of dielectric sheets for the second outer layer portion, which are dielectric sheets produced by using the dielectric paste used for forming the outer layer portion, are stacked. On top of the stack, dielectric sheets used for forming the inner layer portion and provided with an inner electrode pattern are stacked sequentially. Further, on top of the resulting stack, a predetermined number of dielectric sheets for the first outer layer portion, which are dielectric sheets produced by using the dielectric paste used for forming the outer layer portion, are stacked. A sheet stack is thus produced.

Subsequently, the sheet stack is pressed in the stacking direction T by, for example, isostatic pressing or the like to thus produce a multilayer block.

Subsequently, the multilayer block is cut into portions of a predetermined size to obtain each individual multilayer chip.

Then, the multilayer chip is fired to produce the multilayer body 2. Although depending on the material of the dielectric or the inner electrode 15, the firing temperature is preferably, for example, higher than or equal to about 900° C. and lower than or equal to about 1400° C.

Subsequently, by the dipping method, the first end surface C1 of the multilayer body 2 is dipped into a conductive paste that defines and functions as an electrode material used for forming the base electrode layer. The conductive paste used for forming the base electrode layer 31 is thus applied onto the first end surface C1. Similarly, the second end surface C2 of the multilayer body 2 is dipped into a conductive paste that serves as an electrode material used for forming the base electrode layer. The conductive paste used for forming the base electrode layer 31 is thus applied onto the second end surface C2. These conductive pastes are then fired to form the base electrode layer 31 as a fired layer. The firing temperature is preferably, for example, higher than or equal to about 600° C. and lower than or equal to about 900° C.

The plating layer 32 is then formed on the surface of the base electrode layer 31 to form the outer electrode 3. The multilayer ceramic capacitor 1 according to the present example embodiment is thus obtained through the steps described above.

Although example embodiments of the present invention have been described above, it is to be understood that the present invention is not limited to the example embodiments described above but may include various changes and modifications described below.

Although the foregoing descriptions of the example embodiments above are directed to a two-terminal multilayer ceramic capacitor, this is not intended to limit the present invention. Example embodiments of the present invention are also applicable to a three-terminal multilayer ceramic capacitor.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
two major surfaces opposite to each other in a stacking direction;
two end surfaces opposite to each other in a longitudinal direction intersecting the stacking direction; and
two side surfaces opposite to each other in a transverse direction intersecting the stacking direction and the longitudinal direction; and
an outer electrode on each of the two end surfaces of the multilayer body; wherein
the multilayer body includes:
an inner layer portion; and
an outer layer portion on opposite sides of the inner layer portion in the stacking direction;
the inner layer portion includes an inner dielectric layer;
the outer layer portion and the inner dielectric layer each include barium titanate as a major component, and Si as a minor component;
a gap region is located between the inner electrode and each of the two end surfaces or between the inner electrode and each of the two side surfaces; and
a skewness of Si in the inner dielectric layer within the gap region is greater than a skewness of Si in the outer layer portion.

2. The multilayer ceramic capacitor according to claim 1, wherein the skewness of Si in the outer layer portion and the skewness of Si in the inner dielectric layer within the gap region are greater than 0 and less than or equal to about 0.5.

3. The multilayer ceramic capacitor according to claim 1, wherein the skewness of Si in the inner dielectric layer within the gap region is greater by about 0.5% or more than the skewness of Si in the outer layer portion.

4. The multilayer ceramic capacitor according to claim 1, wherein a content of Si within a portion of the gap region located in a vicinity of a center of the gap region in the stacking direction is greater than or equal to about 0.2 at % and less than or equal to about 5.0 at %.

5. The multilayer ceramic capacitor according to claim 1, wherein a content of Mn in the outer layer portion is greater than a content of Mn within a portion of the gap region located in a vicinity of a center of the gap region in the stacking direction.

6. The multilayer ceramic capacitor according to claim 1, wherein the inner dielectric layer has a ceramic grain size D50 of less than or equal to about 0.15 μm.

7. The multilayer ceramic capacitor according to claim 1, wherein the inner dielectric layer has a thickness of less than or equal to about 0.45 μm in the stacking direction.

8. The multilayer ceramic capacitor according to claim 1, wherein the inner electrode includes Ni, Cu, Ag, Pd, or Au or an alloy including at least one of Ni, Cu, Ag, Pd, or Au.

9. The multilayer ceramic capacitor according to claim 1, wherein the inner electrode has a thickness of greater than or equal to about 0.25 μm and less than or equal to about 0.6 μm.

10. The multilayer ceramic capacitor according to claim 1, wherein the outer electrode includes a base electrode layer, and a plating layer on the base electrode layer.

11. The multilayer ceramic capacitor according to claim 10, wherein the base electrode layer includes metal and glass.

12. The multilayer ceramic capacitor according to claim 11, wherein the metal includes at least one of copper, nickel, silver, palladium, a silver-palladium alloy, or gold.

13. The multilayer ceramic capacitor according to claim 11, wherein the glass include boron or silicon.

14. The multilayer ceramic capacitor according to claim 10, wherein the plating layer includes a nickel plating layer on the base electrode layer, and a tin plating layer on the nickel plating layer.
